(19) United States
(12) Patent Application Publication
(10) Pub. No.: US 2023/0415262 A1
(43) Pub. Date: Dec. 28, 2023

(54) LASER PROCESSING APPARATUS

(71) Applicant: DISCO CORPORATION, Tokyo (JP)

(72) Inventor: Hiroshi MORIKAZU, Tokyo (JP)

(21) Appl. No.: 18/332,920

(22) Filed: Jun. 12, 2023

(30) Foreign Application Priority Data
Jun. 23, 2022 (JP) 2022-101243

(51) Int. Cl. B23K 26/082; B23K 26/06; B23K 26/073

(52) U.S. Cl. CPC B23K 26/082; B23K 26/0648; B23K 26/073

(57) ABSTRACT

A controller includes a spot shape storing section that stores the shape of a spot of a laser beam with which a wafer held by a chuck table is irradiated, and a processing shape storing section that stores X-coordinates and Y-coordinates on a processing shape to be formed in the wafer. When the wafer is irradiated with the spot of the laser beam, an X-axis optical scanner and a Y-axis optical scanner are controlled on the basis of the shape of the spot, and the X-coordinates and Y-coordinates on the processing shape and irradiation with the laser beam is executed so that that the contour of the shape of the spot is positioned to an X-coordinate and Y-coordinate on the processing shape, and that a tangent line to the spot and a tangent line to the processing shape at the X-coordinate and Y-coordinate correspond with each other.

### BACKGROUND OF THE INVENTION

### Field of the Invention

The present invention relates to a laser processing apparatus that irradiates a workpiece with a laser beam to execute processing.

### Description of the Related Art

A wafer on which multiple devices such as integrated circuits (ICs) and large-scale integrations (LSIs) are formed on a front surface in such a manner as to be marked out by multiple planned dividing lines that intersect each other is divided into individual device chips by a dicing apparatus or a laser processing apparatus, and the device chips obtained by the dividing are used for pieces of electrical equipment such as mobile phones and personal computers.

Furthermore, a technique is also implemented in which a small hole is formed in the back surface of an electrode pad formed on a device chip and thereafter an electrically-conductive member is buried in the small hole to form a via hole and the device chips are vertically stacked to intend enhancement of functions of a device. The present assignee has proposed a technique for irradiating the back surface of a device chip corresponding to an electrode pad with a laser beam and properly forming a small hole (refer to Japanese Patent No. 6034030).

### SUMMARY OF THE INVENTION

In the technique described in the above-described Japanese Patent No. 6034030, plasma light emitted due to irradiation with the laser beam from the back surface of a substrate on which devices are formed on the front surface is detected. In addition, the irradiation with the laser beam is stopped when plasma light emitted due to reaching of the laser beam to the electrode pad is detected. This can form a proper small hole without opening an unintended through-hole in the electrode pad.

Incidentally, it has turned out that the following problem exists. The spot shape of the laser beam with which a workpiece is irradiated does not become an exact circle but becomes an elliptical shape, for example, in some cases, and the amount of processing in the major axis direction becomes large compared with the amount of processing in the minor axis direction. Thus, even when irradiation with the laser beam is executed along the outer edge of a small hole that is a processing shape to be formed, the shape of the small hole does not become the desired shape but becomes distorted, which lowers the quality of a device chip. Such a problem is not limited to the case of processing the inside of the processing shape as an unnecessary region as in the processing of the above-described small hole. A similar problem possibly occurs also in the case of processing the outside of the processing shape as an unnecessary region.

Thus, an object of the present invention is to provide a laser processing apparatus that allows processing into a desired shape even when the spot shape of a laser beam is a distorted shape like an elliptical shape, for example.

In accordance with an aspect of the present invention, there is provided a laser processing apparatus including a chuck table having a holding surface that holds a workpiece and is defined by an X-axis direction and a Y-axis direction, and a laser beam irradiation unit that irradiates the workpiece held by the chuck table with a laser beam. The laser beam irradiation unit includes a laser oscillator that emits the laser beam, an fθ lens that focuses the laser beam emitted by the laser oscillator on the workpiece held by the chuck table, an X-axis optical scanner that is disposed between the laser oscillator and the fθ lens and induces the laser beam emitted by the laser oscillator in the X-axis direction, a Y-axis optical scanner that is disposed between the laser oscillator and the fθ lens and induces the laser beam emitted by the laser oscillator in the Y-axis direction, and a controller. The controller includes a spot shape storing section that stores a shape of a spot of the laser beam with which the workpiece held by the chuck table is irradiated, and a processing shape storing section that stores X-coordinates and Y-coordinates on a processing shape to be formed in the workpiece held by the chuck table. When the workpiece held by the chuck table is irradiated with the laser beam, the controller controls the X-axis optical scanner and the Y-axis optical scanner on the basis of the shape of the spot and the X-coordinates and Y-coordinates on the processing shape and irradiation with the laser beam is executed in such a manner that the contour of the shape of the spot is positioned to an X-coordinate and Y-coordinate on the processing shape and a tangent line to the spot and a tangent line to the processing shape at the X-coordinate and Y-coordinate correspond with each other.

Preferably, the spot is positioned to the inside of the processing shape when the inside of the processing shape is deemed as unnecessary, and the spot is positioned to the outside of the processing shape when the outside of the processing shape is deemed as unnecessary.

According to the laser processing apparatus of the present invention, even when the shape of the spot of the laser beam is a distorted shape like an elliptical shape, for example, processing into the desired processing shape is possible and a problem that the processing shape that should be formed becomes distorted is eliminated. This can eliminate, for example, a problem that the quality of device chips in which small holes are formed corresponding to electrode pads lowers.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is an overall perspective view of a laser processing apparatus;

FIG. 2 is a block diagram illustrating the outline of a laser beam irradiation unit mounted in the laser processing apparatus illustrated in FIG. 1;

FIG. 3 is a perspective view illustrating a wafer to be processed by the laser processing apparatus of FIG. 1;

FIG. 4 is a conceptual diagram of a controller disposed in the laser processing apparatus illustrated in FIG. 1; and

FIG. 5A and FIG. 5B are conceptual diagrams illustrating a processing shape and the shape of a spot when laser processing is executed by the laser processing apparatus illustrated in FIG. 1.

### DETAILED DESCRIPTION OF THE PREFERRED EMBODIMENT

A laser processing apparatus of an embodiment of the present invention will be described in detail below with reference to the accompanying drawings.

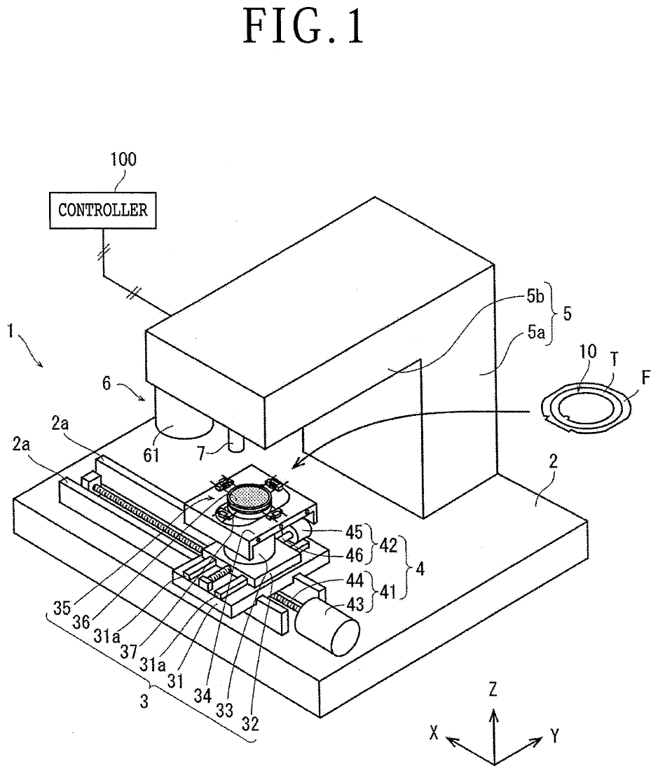

In FIG. 1, an overall perspective view of a laser processing apparatus 1 of the present embodiment is illustrated. The laser processing apparatus 1 includes holding means 3 that is disposed over a base 2 and includes a chuck table 35 having a holding surface 36 that holds a wafer 10 that is an illustrated workpiece and is defined by an X-axis direction and a Y-axis direction, and a laser beam irradiation unit 6 that irradiates the wafer 10 held by the chuck table 35 with a laser beam.

Furthermore, the laser processing apparatus 1 includes a movement mechanism 4 including an X-axis feed mechanism 41 that moves the chuck table 35 in the X-axis direction and a Y-axis feed mechanism 42 that moves the chuck table 35 in the Y-axis direction, a frame body 5 including a vertical wall part 5a erected on a lateral side of the movement mechanism 4 on the base 2 and a horizontal wall part 5b extending in the horizontal direction from an upper end part of the vertical wall part 5a, an imaging unit 7 that images the wafer 10 held by the chuck table 35 and executes alignment, and a controller 100. An input unit, a display unit, and so forth that are not illustrated are connected to the controller 100.

As illustrated in FIG. 1, the holding means 3 includes a rectangular X-axis direction movable plate 31 mounted over the base 2 movably in the X-axis direction, a rectangular Y-axis direction movable plate 32 mounted over the X-axis direction movable plate 31 movably in the Y-axis direction, a circular cylindrical support column 33 fixed to the upper surface of the Y-axis direction movable plate 32, and a rectangular cover plate 34 fixed to the upper end of the support column 33. The chuck table 35 that passes through a long hole formed on the cover plate 34 and extends upward is disposed over the cover plate 34. The chuck table 35 is configured to be capable of rotating by a rotational drive mechanism that is housed in the support column 33 and is not illustrated. At the upper surface of the chuck table 35, the holding surface 36 that is formed of a porous material having gas permeability and is defined by the X-axis direction and the Y-axis direction is formed. The holding surface 36 is connected to suction means, which is not illustrated, by a flow path passing through the support column 33. Around the holding surface 36, four clamps 37 used when the wafer 10 to be described later is held over the chuck table 35 are disposed at equal intervals. The wafer 10 can be held under suction on the holding surface 36 of the chuck table 35 by actuating the suction means.

The X-axis feed mechanism 41 converts rotational motion of a motor 43 to linear motion through a ball screw 44 and transmits the linear motion to the X-axis direction movable plate 31 to move the X-axis direction movable plate 31 in the X-axis direction along a pair of guide rails 2a disposed along the X-axis direction on the base 2. The Y-axis feed mechanism 42 converts rotational motion of a motor 45 to linear motion through a ball screw 46 and transmits the linear motion to the Y-axis direction movable plate 32 to move the Y-axis direction movable plate 32 in the Y-axis direction along a pair of guide rails 31a disposed along the Y-axis direction on the X-axis direction movable plate 31.

An optical system that configures the above-described laser beam irradiation unit 6, and the imaging unit 7 are housed inside the horizontal wall part 5b of the frame body 5. A light collector 61 that configures part of the laser beam irradiation unit 6 and irradiates the wafer 10 with a laser beam LB is disposed on the lower surface side of a tip part of the horizontal wall part 5b. A normal charge coupled device (CCD) camera that executes imaging by a visible beam is used as the imaging unit 7 in general. However, in the present embodiment, an infrared camera that can image an electrode pad formed on the front surface of a device 12 from a back surface 10b of the wafer 10 is employed and is disposed at a position adjacent to the above-described light collector 61 in the X-axis direction.

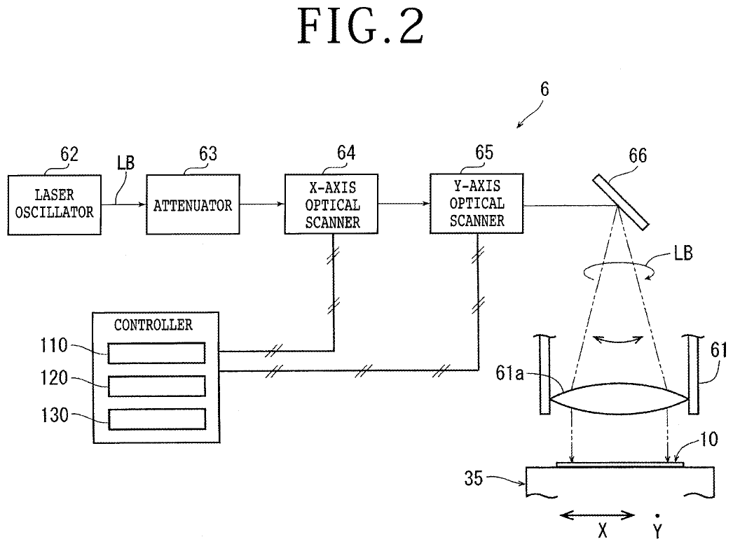

In FIG. 2, a block diagram illustrating one example of the optical system of the above-described laser beam irradiation unit 6 is illustrated. The laser beam irradiation unit 6 of the present embodiment includes a laser oscillator 62 that emits the laser beam LB, an attenuator 63 that adjusts the output power of the laser beam LB emitted by the laser oscillator 62, and the light collector 61 including an fθ lens 61a. An X-axis optical scanner 64 and a Y-axis optical scanner 65 are disposed between the laser oscillator 62 and the fθ lens 61a. The X-axis optical scanner 64 induces the laser beam LB in the X-axis direction of the wafer 10 held by the holding surface 36 of the chuck table 35. The Y-axis optical scanner 65 induces the laser beam LB in the Y-axis direction of the wafer 10 held by the holding surface 36 of the chuck table 35. Moreover, a reflective mirror 66 that changes the optical path of the laser beam LB to the side of the light collector 61 is disposed between the Y-axis optical scanner 65 and the light collector 61. The X-axis optical scanner 64 and the Y-axis optical scanner 65 are configured by a galvano scanner, for example. The X-axis optical scanner 64 and the Y-axis optical scanner 65 are not limited to the above-described galvano scanner and may be what uses an acousto-optical element (AOE) or a diffractive optical element (DOE).

The controller 100 is configured by a computer and includes a central processing unit (CPU) that executes calculation processing in accordance with a control program, a read only memory (ROM) that stores the control program and so forth, a readable-writable random access memory (RAM) for temporarily storing a calculation result and so forth, an input interface, and an output interface. To the controller 100, the laser beam irradiation unit 6 (X-axis optical scanner 64, Y-axis optical scanner 65), the imaging unit 7, the X-axis feed mechanism 41, the Y-axis feed mechanism 42, and so forth are connected.

When the wafer 10 that is a workpiece is irradiated with the laser beam LB oscillated by the laser oscillator 62 by the above-described laser beam irradiation unit 6, the X-axis optical scanner 64 and the Y-axis optical scanner 65 are controlled by the controller 100. In addition, in conjunction with this, the above-described X-axis feed mechanism 41 and Y-axis feed mechanism 42 are also controlled. This makes it possible to position the chuck table 35 directly under the light collector 61 and precisely position the center position of a spot S of the laser beam LB to be described later to a desired X-coordinate/Y-coordinate position on the wafer 10 held by the chuck table 35 and execute irradiation.

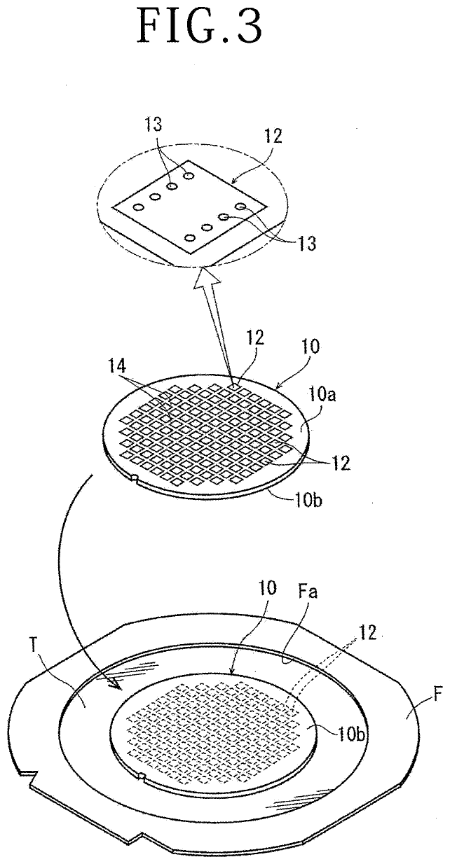

In FIG. 3, a perspective view of the wafer 10 composed of silicon is illustrated as a workpiece for which laser processing is executed by the laser processing apparatus 1 of the present embodiment. The wafer 10 is a wafer on which multiple devices 12 are formed on a front surface 10a in such a manner as to be marked out by multiple planned dividing lines 14 that intersect each other. As illustrated in an enlarged view of part of the front surface 10a of the wafer 10 on the upper side of FIG. 3, multiple electrode pads (hereinafter, referred to as “bumps”) 13 are formed on all devices 12. In the present embodiment, by the laser processing apparatus 1, corresponding to these multiple bumps 13, small holes that reach the bumps 13 are formed from the side of the back surface 10b of the wafer 10.

When the wafer 10 is processed by the laser processing apparatus 1 of the present embodiment, as illustrated in FIG. 3, an annular frame F having an opening Fa in which the wafer 10 can be housed is prepared, the wafer 10 is housed at the center of the opening Fa with the back surface 10b of the wafer 10 oriented upward, and the wafer 10 and the annular frame F are stuck to a protective tape T to be integrated. Then, as illustrated in FIG. 1, the wafer 10 supported by the annular frame F is placed over the holding surface 36 of the chuck table 35 and is held under suction. In addition, the wafer 10 is fixed by the clamps 37.

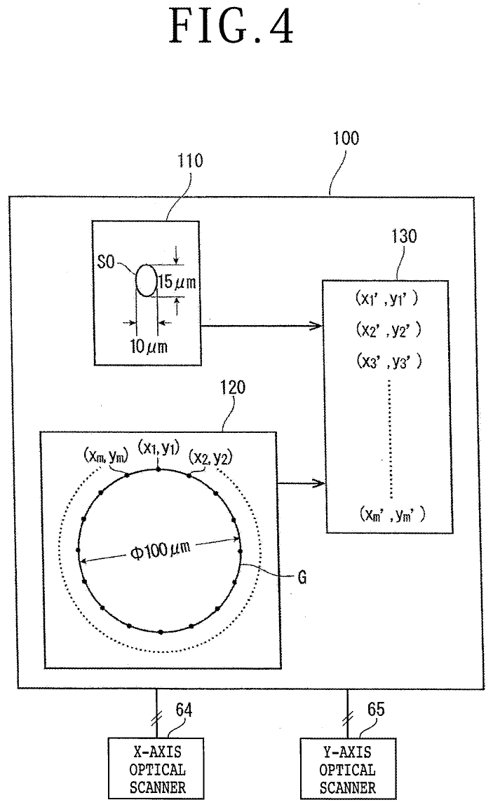

As illustrated in FIGS. 2 and 4, the controller 100 of the laser processing apparatus 1 includes a spot shape storing section 110 that stores the shape (including also dimension information) of the spot S of the laser beam LB with which the wafer 10 held by the chuck table 35 is irradiated, a processing shape storing section 120 that stores X-coordinates and Y-coordinates ((x1, y1) to (xm, ym)) that define the shape of a processing shape G to be formed in the wafer 10 held by the chuck table 35, and a spot center coordinates storing section 130 that stores the X-coordinates and Y-coordinates ((x1′, y1′) to (xm′, ym′)) of the center of the spot S when the wafer 10 is irradiated with the laser beam LB.

The shape and dimensions of the spot S of the laser beam LB stored in the spot shape storing section 110 of the above-described present embodiment are what are measured by an experiment and are stored in advance, and are, for example, an elliptical shape in which the length of the major axis is 15 μm and the length of the minor axis is 10 μm as illustrated in FIG. 4. Furthermore, the processing shape G stored in the processing shape storing section 120 is what defines the processing shape of a small hole to be formed in the back surface 10b at a position corresponding to the bump 13 of the device 12 formed on the front surface 10a of the wafer 10. As illustrated in FIG. 4, the processing shape of the small hole is an exact circle with a diameter of 100 μm and is identified by X-coordinates and Y-coordinates ((x1, y1), (x2, y2), (x3, y3) . . . (xm, ym)) defined with a predetermined position (for example, center) of the processing shape G regarded as the origin. The processing shape G of the present embodiment is what defines a processing shape whose inside is unnecessary, and the small hole that reaches the bump 13 is formed from the side of the back surface 10b at a position corresponding to the bump 13 by laser processing in which the spot S of the laser beam LB is positioned to the inside of the processing shape G.

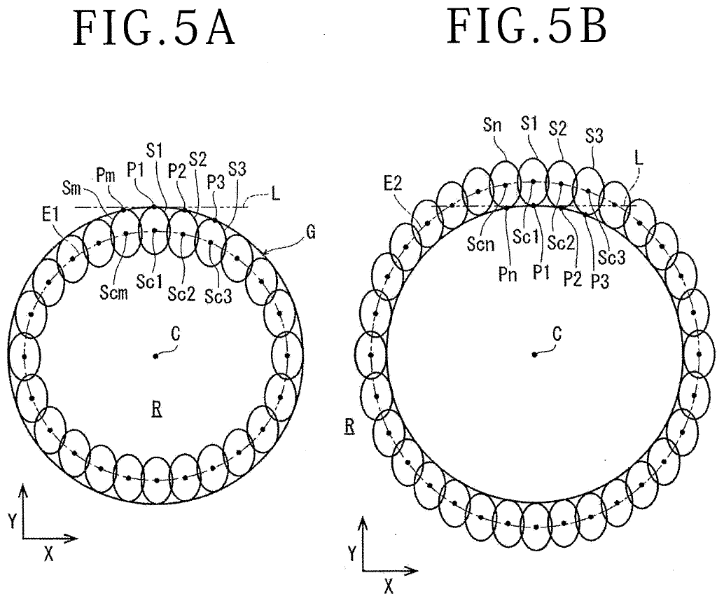

As illustrated in FIG. 5A, the X-coordinates and Y-coordinates of the centers of the spot S are what are calculated on the basis of the above-described shape and dimensions of the spot S of the laser beam LB and the X-coordinates and Y-coordinates of points P1 to Pm on the processing shape G, and are calculated in such a manner that the contour of the spot S is positioned to a predetermined X-coordinate and Y-coordinate on the processing shape G and a tangent line to the spot S and a tangent line to the processing shape G at the predetermined X-coordinate and Y-coordinate correspond with each other when the wafer 10 held by the chuck table 35 is irradiated with the spot S. In FIG. 5A, it is illustrated that the contour of a spot S1 is positioned to the point P1 on the processing shape G and a tangent line L at the point P1 corresponds with a tangent line to the spot S1. X-coordinates and Y-coordinates (x1′, y1′), (x2′, y2′), (x3′, y3′), . . . (xm′, ym′) of centers Sc1 to Scm of the spot S calculated in this manner are stored in the above-described spot center coordinates storing section 130.

As is understood from FIG. 5A, the processing shape G that forms the small hole is set as the exact circle centered at a point C, whereas a first locus E1 (illustrated by a one-dot chain line) formed by the X-coordinates and Y-coordinates of the centers Sc1 to Scm of the spot S does not become an exact circle but becomes a substantially elliptical shape compressed in the vertical direction (Y-axis direction) because the shape of the spot S is an elliptical shape. In the present embodiment, the elliptical spot S applied onto the wafer 10 has an elliptical shape in which the minor axis is formed in the X-axis direction and the major axis is formed in the Y-axis direction at whichever position it is applied.

The laser processing apparatus 1 of the present embodiment has a configuration that is substantially as described above. Functions and operation thereof will be described below.

After the wafer 10 integrated with the annular frame F, which is described on the basis of FIG. 3, through the protective tape T is prepared, the wafer 10 is placed over the chuck table 35 of the laser processing apparatus 1, which is described on the basis of FIG. 1, with the back surface 10b of the wafer 10 oriented upward, and the wafer 10 is held under suction to be fixed by the clamps 37.

Subsequently, the X-axis feed mechanism 41 and the Y-axis feed mechanism 42 are actuated, and the wafer 10 is positioned directly under the imaging unit 7. Then, the wafer 10 is imaged by the imaging unit 7 including the infrared camera, and alignment to detect the device 12 formed on the front surface 10a of the wafer 10 and the planned dividing line 14 is executed. As described above, the multiple bumps 13 are formed on each of the devices 12 formed on the wafer 10. Position coordinates corresponding to the respective bumps 13 are detected and are stored in the controller 100. In the above-described alignment, the positions of the bumps 13 do not need to be directly detected. By storing the positions at which the bumps 13 are formed on the device 12 in advance and identifying the position and orientation of the device 12, the position coordinates of the bumps 13 formed on the device 12 can also be identified.

After the position coordinates of the bumps 13 formed on the device 12 are detected as described above, the X-axis feed mechanism 41 and the Y-axis feed mechanism 42 are actuated, and the chuck table 35 is positioned directly under the light collector 61. Subsequently, the laser oscillator 62 is actuated, and the X-axis optical scanner 64 and the Y-axis optical scanner 65 of the above-described laser beam irradiation unit 6 are controlled on the basis of the X-coordinates and Y-coordinates (x1′, y1′) to (xm′, ym′) of the centers Sc1 to Scm of the spot S calculated on the basis of the shape of the spot S and information relating to the X-coordinates and Y-coordinates on the processing shape G described above. Thus, as illustrated in FIG. 5A, the spot S of the laser beam LB is positioned along the processing shape G, and irradiation is executed at a predetermined position on the back surface 10b of the wafer 10 corresponding to the bump 13. The X-coordinates and Y-coordinates stored in the spot center coordinates storing section 130 are converted to X-coordinates and Y-coordinates on the chuck table 35 as appropriate by the controller 100, and an instruction signal is given to the above-described X-axis optical scanner 64 and Y-axis optical scanner 65.

Laser processing conditions when the above-described laser processing is executed are set as follows, for example.
Wavelength: 343 nm
Repetition frequency: 50 kHz
Average output power: 2 W
Pulse energy: 40 μJ
Pulse width: 10 ps

In the above-described laser processing, irradiation with the laser beam LB is executed in such a manner that the centers Sc1 to Scm of the spot S are along the first locus E1 illustrated by the one-dot chain line as illustrated in FIG. 5. Due to this, the laser processing is executed in such a manner that the contour of the spot S is positioned to X-coordinates and Y-coordinates on the processing shape G, and that a tangent line to the processing shape G at the X-coordinate and Y-coordinate of each of the points P1 to Pm corresponds with a tangent line to the contour of the spot S. By repeatedly executing such laser irradiation, a small hole is formed with the processing shape G that is the exact circle by the spot S with the elliptical shape. In the present embodiment, the whole of the inside of the processing shape G is an unnecessary region, and processing to form the small hole that reaches the above-described bump 13 on the side of the front surface 10a of the wafer 10 is necessary. Thus, irradiation with the laser beam LB is repeatedly executed also for the region inside the above-described first locus E1, and the whole of the inside of the processing shape G is removed until a depth that reaches the bump 13 formed on the side of the front surface 10a. Whether or not the small hole has reached the bump 13 can be determined by receiving peculiar plasma light emitted when the laser beam LB reaches the bump 13 as described in the above-described Japanese Patent No. 6034030, and the irradiation with the laser beam LB can be properly stopped to keep the small hole formed by the laser beam LB from penetrating the bump 13. The above-described laser processing is executed for each of the bumps 13 formed on all devices 12 of the wafer 10, and small holes are formed from the side of the back surface 10b corresponding to the bumps 13.

According to the above-described embodiment, even when the shape of the spot S of the laser beam LB is a distorted shape like an elliptical shape, for example, processing into the desired processing shape G is possible, and the problem that the shape of the small hole that should be formed becomes distorted to lower the quality of device chips formed through dividing the wafer 10 is eliminated.

The present invention is not limited to the above-described embodiment. In the above-described embodiment, the small hole for which the inside of the processing shape G is deemed as unnecessary is formed. However, for example, as illustrated in FIG. 5B, processing in which the outside of the processing shape G is removed as an unnecessary region and the inside of the processing shape G is left may be executed. In this case, the X-coordinates and Y-coordinates of centers Sc1 to Scn of the spot S stored in the spot center coordinates storing section 130 of the controller 100 are calculated in such a manner that, as illustrated in FIG. 5B, the contour of the spot S is positioned to points P1 to Pn that define the processing shape G from the outside of the processing shape G and a tangent line to the processing shape G at the X-coordinate and Y-coordinate of the point P1 to Pn that defines the processing shape G corresponds with a tangent line to the spot S at the point P1 to Pn. The X-coordinates and Y-coordinates of the centers Sc1 to Scn of the spot S calculated in this manner are stored in the spot center coordinates storing section 130, and laser processing is executed along a second locus E2 (illustrated by a one-dot chain line) defined by the centers Sc1 to Scn.

The processing shape G of the embodiment illustrated in FIG. 5B is set as the exact circle centered at the point C. In contrast, the second locus E2 formed by the centers Sc1 to Scn of the spot S of the laser beam LB with which the outside of the processing shape G is irradiated does not become an exact circle but becomes a vertically-long elliptical shape compressed in the horizontal direction (X-axis direction) because the shape of the spot S is an elliptical shape. Also by such an embodiment, similarly to the above-described embodiment, even when the shape of the spot S of the laser beam LB is a distorted shape like an elliptical shape, for example, processing into the desired processing shape G is possible, and the problem that the processing shape G that should be formed does not become the intended shape but becomes distorted is eliminated.

Moreover, although examples in which the processing shape G is an exact circle have been explained in the above-described embodiments, the present invention is not limited thereto and it is also possible to set the processing shape G as an optional shape.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a chuck table having a holding surface that holds a workpiece and is defined by an X-axis direction and a Y-axis direction; and
a laser beam irradiation unit that irradiates the workpiece held by the chuck table with a laser beam,
wherein the laser beam irradiation unit includes
a laser oscillator that emits the laser beam,
an fθ lens that focuses the laser beam emitted by the laser oscillator on the workpiece held by the chuck table,
an X-axis optical scanner that is disposed between the laser oscillator and the fθ lens, and induces the laser beam emitted by the laser oscillator in the X-axis direction,
a Y-axis optical scanner that is disposed between the laser oscillator and the fθ lens, and induces the laser beam emitted by the laser oscillator in the Y-axis direction, and
a controller,
wherein the controller includes a spot shape storing section that stores a shape of a spot of the laser beam with which the workpiece held by the chuck table is irradiated, and a processing shape storing section that stores X-coordinates and Y-coordinates on a processing shape to be formed in the workpiece held by the chuck table, and,
when the workpiece held by the chuck table is irradiated with the laser beam, the controller controls the X-axis optical scanner and the Y-axis optical scanner on a basis of the shape of the spot and the X-coordinates and Y-coordinates on the processing shape, and irradiation with the laser beam is executed in such a manner that a contour of the shape of the spot is positioned to an X-coordinate and Y-coordinate on the processing shape, and that a tangent line to the spot and a tangent line to the processing shape at the X-coordinate and Y-coordinate correspond with each other.

2. The laser processing apparatus according to claim 1, wherein
the spot is positioned to an inside of the processing shape when the inside of the processing shape is deemed as unnecessary, and the spot is positioned to an outside of the processing shape when the outside of the processing shape is deemed as unnecessary.
